(19) United States
(12) Patent Application Publication
(10) Pub. No.: US 2025/0256228 A1
(43) Pub. Date: Aug. 14, 2025

(54) Removable Pipe Filter Device

(71) Applicants: Edward McShan, II, West Los Angeles, CA (US); Gregory Amyx, West Los Angeles, CA (US)

(72) Inventors: Edward McShan, II, West Los Angeles, CA (US); Gregory Amyx, West Los Angeles, CA (US)

(21) Appl. No.: 18/440,616

(22) Filed: Feb. 13, 2024

(51) Int. Cl. B01D 35/02; B01D 29/05

(52) U.S. Cl. CPC B01D 35/023; B01D 29/05

(57) ABSTRACT

A removable pipe filter device for blocking and removing debris from traveling through piping includes a first pipe having a pair of open ends being configured for connection to a drainpipe. The first pipe defines a conduit between the pair of open ends. A second pipe is coupled to the first pipe. The second pipe is in environmental communication with the conduit between the pair of open ends of the first pipe. The second pipe has a distal edge relative to the first pipe defining an opening into the second pipe. A filter is releasably couplable to the second pipe. The filter extends into the second pipe. The filter inhibits solid debris entering the conduit through a first end of the pair of open ends from exiting the conduit through a second end of the pair of open ends when the filter is coupled to the second pipe.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to filters and more particularly pertains to a new filter for blocking and removing debris from traveling through piping.

### (2) Description of Related Art Including Information Disclosed Under 37 CFR 1.97 and 1.98

The prior art relates to filters. More particularly, the prior art relates to filters for blocking solid debris, such as hair, from traveling through drainpipes. Hair clogs are a common and frustrating problem, slowing the flow of water through drainpipes. Once the flow rate of the water is reduced, the water can pool in the bottom of the sink, bathtub, or shower, which can be frustrating and unhygienic. The prior art has disclosed some devices for reducing the amount of hair and other solid debris that travels through drainpipes. For example, the prior art discloses mesh covers for the inlet into a drainpipe to capture hair before the hair enters the drainpipe. However, the devices in the prior art have limited efficacy, and debris buildup remains a prevalent issue. Thus, there is a need in the art for an improved filter device that can catch and trap hair, lint, and other solid debris before the solid debris accumulates and clogs the drainpipe. Ideally, such a device would be easy to install on existing drainpipes and would be easy to remove for cleaning and proper disposal of the solid debris.

### BRIEF SUMMARY OF THE INVENTION

An embodiment of the disclosure meets the needs presented above by generally comprising a first pipe having a pair of open ends being configured for connection to a drainpipe. The first pipe defines a conduit between the pair of open ends. A second pipe is coupled to the first pipe. The second pipe is in environmental communication with the conduit between the pair of open ends of the first pipe. The second pipe has a distal edge relative to the first pipe defining an opening into the second pipe. A filter is releasably couplable to the second pipe. The filter extends into the second pipe. The filter is configured to inhibit solid debris entering the conduit through a first end of the pair of open ends from exiting the conduit through a second end of the pair of open ends when the filter is coupled to the second pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded isometric view of a removable pipe filter device according to an embodiment of the disclosure.

FIG. 2 is a side view of an embodiment of the disclosure.

FIG. 3 is a cross-sectional view of an embodiment of the disclosure.

FIG. 4 is a detail view of an embodiment of the disclosure.

FIG. 5 is a top view of an embodiment of the disclosure.

FIG. 6 is an in-use view of an embodiment of the disclosure.

FIG. 7 is an in-use view of an embodiment of the disclosure.

### DETAILED DESCRIPTION OF THE INVENTION

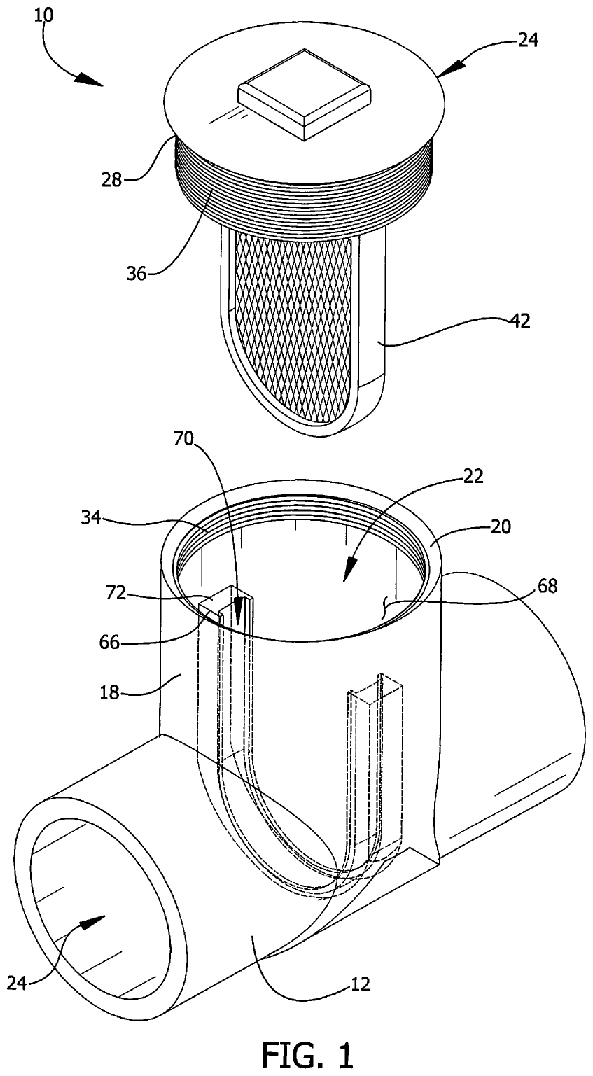

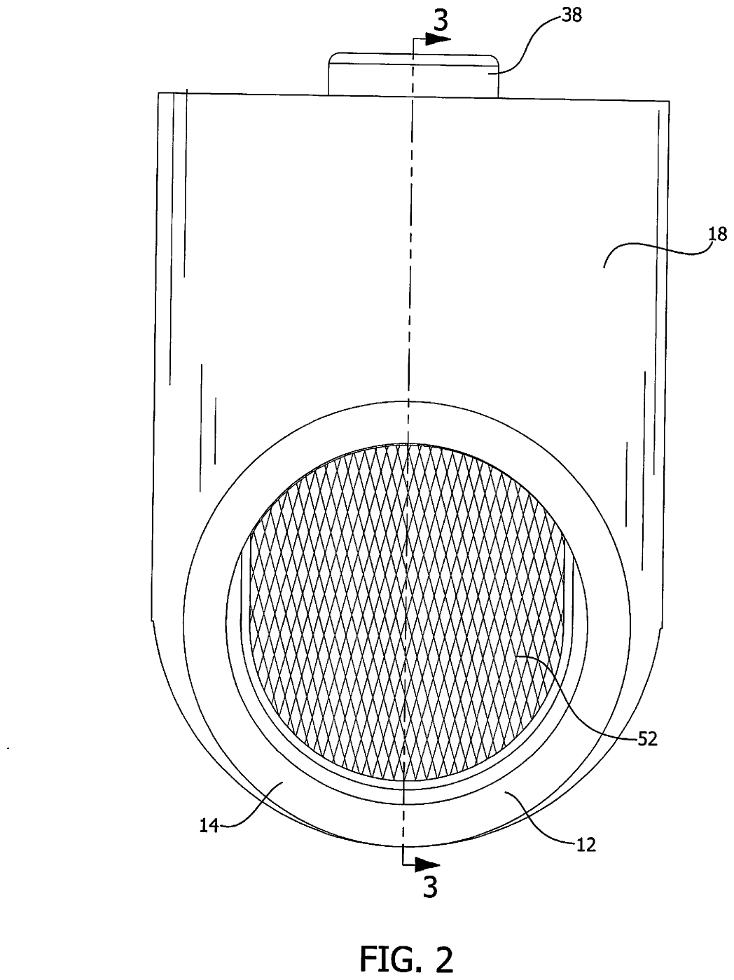

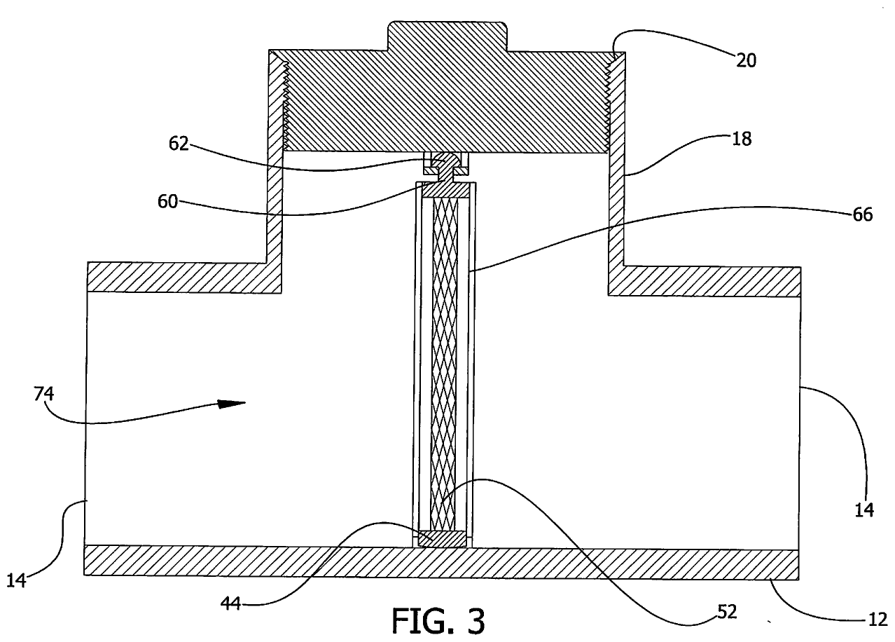

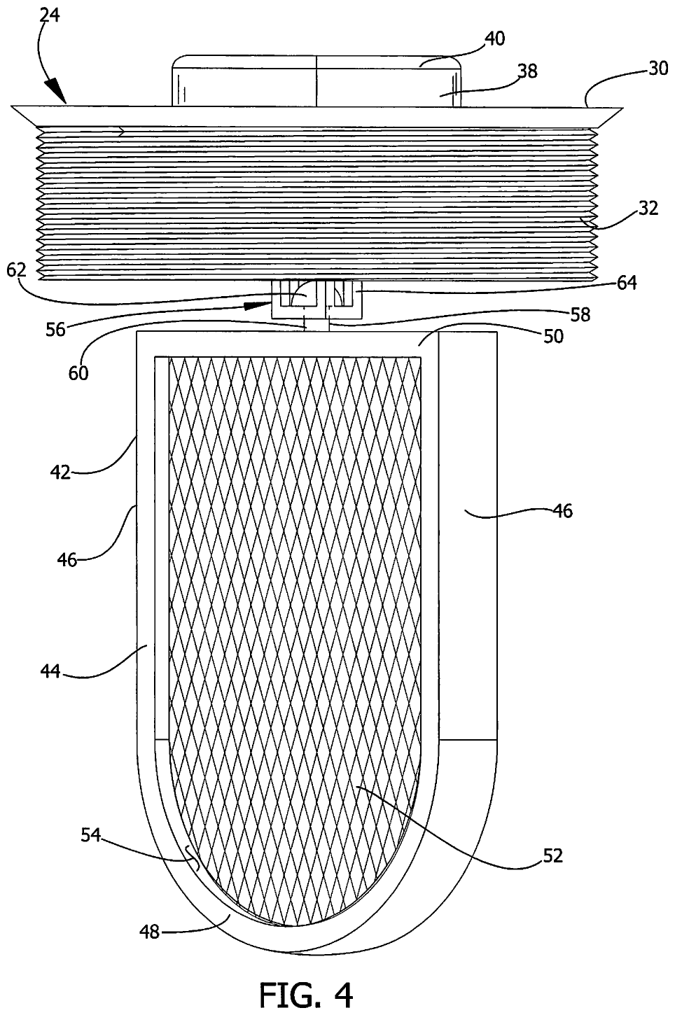

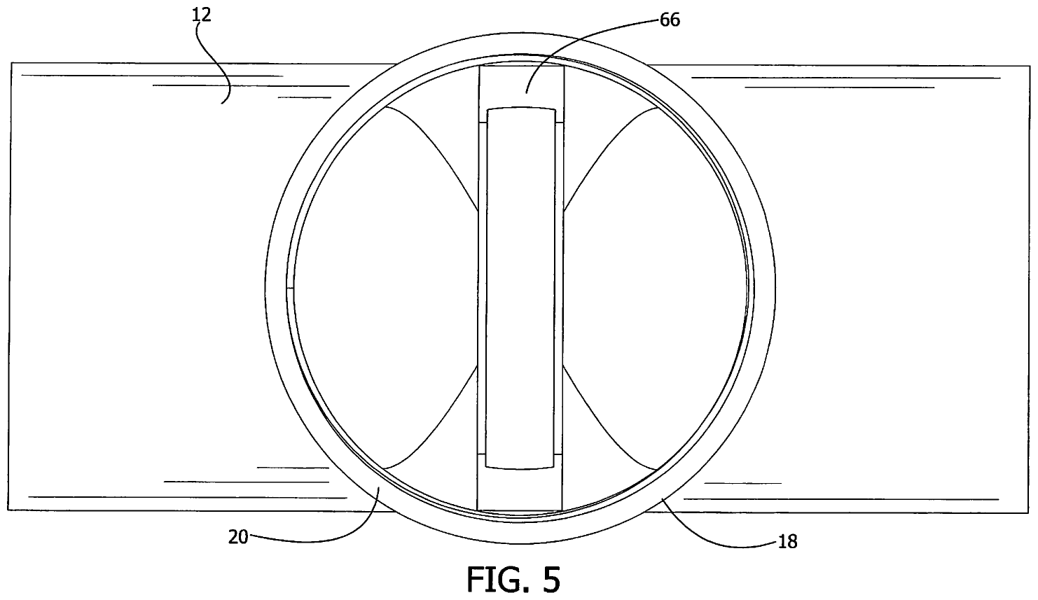

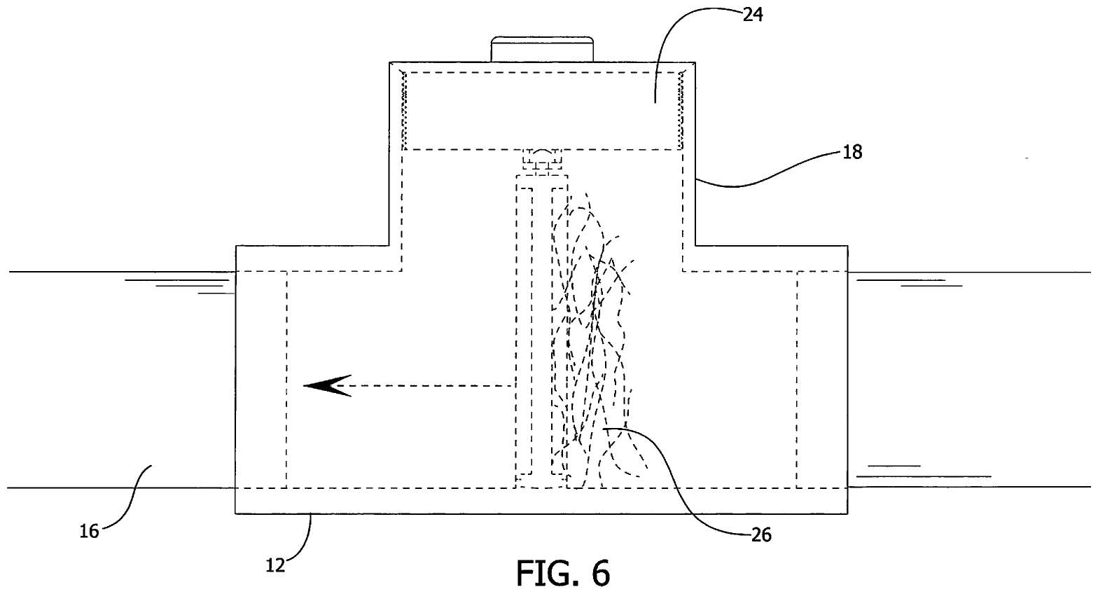

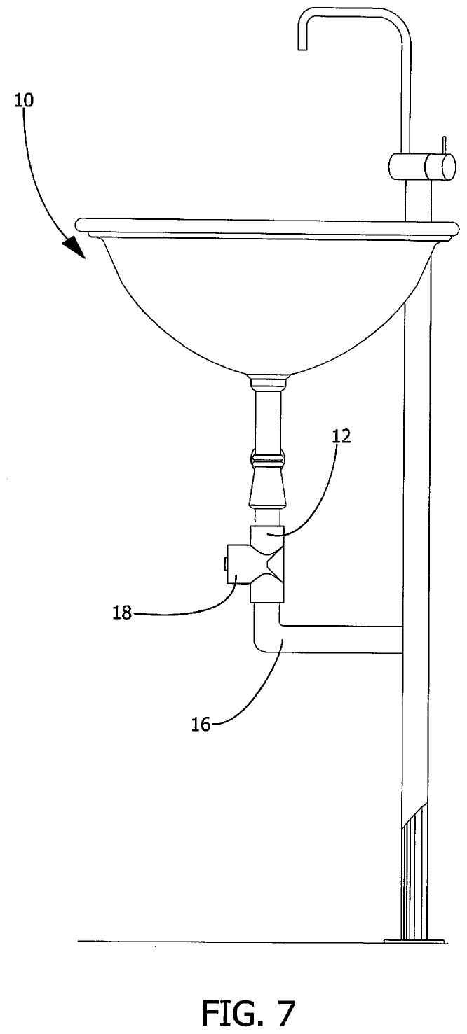

With reference now to the drawings, and in particular to FIGS. 1 through 7 thereof, a new filter embodying the principles and concepts of an embodiment of the disclosure and generally designated by the reference numeral 10 will be described.

As best illustrated in FIGS. 1 through 7, the removable pipe filter device 10 generally comprises a first pipe 12 with a pair of open ends 14 that is configured for connection to a drainpipe 16. The first pipe 12 defines a conduit 74 between the pair of open ends 14. The first pipe 12 may be elongated.

A second pipe 18 is coupled to the first pipe 12. The second pipe 18 is generally positioned between the pair of open ends 14. The second pipe 18 is in environmental communication with the conduit 74 between the pair of open ends 14 of the first pipe 12. The second pipe 18 has a distal edge 20 relative to the first pipe 12. The distal edge 20 defines an opening 22 into the second pipe 18. The second pipe 18 may be perpendicular to the first pipe 12.

A filter 24 is releasably couplable to the second pipe 18. The filter 24 extends into the conduit 74 through the second pipe 29. The filter 24 is configured to inhibit solid debris 26 that enters the conduit 74 through a first end of the pair of open ends 14 from exiting the conduit 74 through a second end of the pair of open ends 14 when the filter 24 is coupled to the second pipe 18. The filter 24 is configured to define a collection point for the solid debris 26 to facilitate removal of the solid debris 26 and inhibit the conduit 74 from becoming fully clogged by the solid debris 26.

The filter 24 may further comprise a cap 28 that has a top plate 30 and a base 32. The cap 28 may have a circular shape that is complementary to a shape of the opening 22 into the second pipe 18. The top plate 30 may have an upper diameter and the base 32 may have a lower diameter. The upper diameter exceeds the lower diameter such that the base 32 is positionable within the opening 22. The upper diameter exceeds an inner diameter of the second pipe 18 wherein the top plate 30 is positionable on the distal edge 20 of the second pipe 18 to cover the opening 22.

The second pipe 18 may have a threaded inner surface 34 that is positioned adjacent to the distal edge 20. The base 32 of the cap 28 may have a threaded outer surface 36. The threaded outer surface 36 of the base 32 is complementary to the threaded inner surface 34 of the second pipe 18 wherein the cap 28 is threadably couplable to the second pipe 18.

A grip 38 may be coupled to and extend upwardly from the top plate 30 of the cap 28. The grip 38 is generally configured to facilitate a user in decoupling the cap 28 from the second pipe 18. The grip 38 may have a square shape. The grip 38 may have a beveled upper edge 40 that is distal to the top plate 30 of the cap 28.

A fin 42 may be coupled to and extend downwardly from the base 32 of the cap 28. The fin 42 extends through the second pipe 18 and into the conduit 70 of the first pipe 12 wherein the fin 42 is positioned between the first end and the second end of the pair of open ends 14 when the filter 24 is coupled to the second pipe 18.

The fin 42 may further comprise a peripheral wall 44 and a mesh panel 52. The peripheral wall 44 may generally have a D-shape, or another shape that is complementary to the shape of the first pipe 12 and the second pipe 18. For example, the peripheral wall 44 may have a pair of opposing lateral sides 46 and a curved side 48 that is coupled to and extends between the pair of opposing lateral sides 46. The pair of opposing lateral sides 46 may be parallel to each other. A straight side 50 may be coupled to and extend between the pair of opposing lateral sides 46. The straight side 50 may be distal to the curved side 48. In other words, the straight side 50 may be positioned proximate to the cap 28 and the curved side 48 may be positioned proximate to the first pipe 12. The straight side 50 may be perpendicular to each of the pair of opposing lateral sides 46. The straight side 50 may have a length that is smaller than the lower diameter of the base 32 of the cap 28.

The curved side 48 may have an interior face 54 that is positioned adjacent to the mesh panel 52. The interior face 54 may be convexly arcuate between a primary side of the pair of opposing lateral sides 46 and a secondary side of the pair of opposing lateral sides 46.

The mesh panel 52 is coupled to the peripheral wall 44. The mesh panel 52 generally extends between the pair of opposing lateral sides 46, the curved side 48, and the straight side 50. The mesh panel 52 is foraminous wherein the mesh panel 52 is configured to inhibit the solid debris 26 from passing through the filter 24 while permitting fluids to pass through the filter 24.

A coupler 56 may pivotably couple the fin 42 to the base 32 of the cap 28 wherein the fin 42 is configured to rotate around the coupler 56 beneath the cap 28. Rotation around the coupler 560 facilitates positioning the mesh panel 52 between the first end and the second end of the pair of open ends 14 of the first pipe 12. For example, when the mesh panel 52 is perpendicular to each of the pair of open ends 14, the mesh panel 52 can function as a blockade between the pair of open ends 14 to inhibit the solid debris 26 from passing through the conduit 74. In some embodiments, the coupler 56 may permit the fin 42 to rotate 360° beneath the cap 28.

The coupler 56 may further comprise a head 58 that is coupled to and extends upwardly from the straight side 50 of the peripheral wall 44. The head 58 may further comprise a bar 60 that is perpendicular to the straight side 50 of the peripheral wall 44. A dome 62 may be coupled to the bar 60 distally to the straight side 50. The dome 62 has a diameter exceeding a diameter of the bar 60. A brace 64 may be coupled to and extend downwardly from the base 32 of the cap 28. The brace 64 may be coupled to the head 58 wherein the head 58 is rotatable within the brace 64.

A rail 66 may be coupled to the first pipe 12 and the second pipe 18. The rail 66 may be positioned on an interior surface 68 of the first pipe 12 and the second pipe 18. The rail 66 may be centrally positioned between the first end and the second end of the pair of open ends 14 of the first pipe 12. The rail 66 engages the filter 24 when the filter 24 is coupled to the second pipe 18 wherein the rail 66 is configured to fix a position of the filter 24 relative to the pair of open ends 14 of the first pipe 12.

The rail 66 may further comprise a groove 70 having a shape that is complementary to a shape of the peripheral wall 44 of the fin 42 wherein the peripheral wall 44 is positionable within the groove 70. A free upper end 72 of the rail 66 may be positioned within the second pipe 18. The free upper end 66 may be spaced from the distal edge 20 of the second pipe 18.

In use, the first pipe 12 is configured to be fluidly coupled to the drainpipe 16 wherein the first end of the pair of open ends 14 defines an inlet into the conduit 74 from a primary pipe of the drainpipe 16 and the second end of the pair of open ends 14 defines an outlet from the conduit 74 into a secondary pipe of the drainpipe 16. The filter 24 is configured to inhibit the solid debris 26 from passing into the secondary pipe of the drainpipe 16 through the outlet. The solid debris 26 can collect at the collection point defined by the filter 24. Because the filter 24 is removable, the solid debris 26 can be easily removed from the collection point without clogging the drainpipe 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pipe filtering assembly comprising:
a first pipe having a pair of open ends being configured for connection to a drainpipe, the first pipe defining a conduit between the pair of open ends;
a second pipe being coupled to the first pipe wherein the second pipe is in environmental communication with the conduit between the pair of open ends of the first pipe, the second pipe having a distal edge relative to the first pipe defining an opening into the second pipe; and
a filter being releasably couplable to the second pipe, the filter extending into the second pipe wherein the filter is configured to inhibit solid debris entering the conduit through a first end of the pair of open ends from exiting the conduit through a second end of the pair of open ends when the filter is coupled to the second pipe.

2. The pipe filtering assembly of claim 1, the filter further comprising:
a cap having a top plate and a base; and
a fin being coupled to and extending downwardly from the base of the cap, the fin extending through the second pipe and into the conduit of the first pipe wherein the fin is positioned between the first end and the second end of the pair of open ends when the filter is coupled to the second pipe.

3. The pipe filtering assembly of claim 2, the fin further comprising:
a peripheral wall; and
a mesh panel being coupled to the peripheral wall, the mesh panel being foraminous wherein the mesh panel is configured to inhibit the solid debris from passing through the filter while permitting fluids to pass through the filter.

4. The pipe filtering assembly of claim 3, further comprising a coupler pivotably coupling the fin to the base of the cap.

5. The pipe filtering assembly of claim 4, the coupler further comprising:
a head being coupled to and extending upwardly from the straight side of the peripheral wall; and
a brace being coupled to and extending downwardly from the base of the cap, the brace being coupled to the head wherein the head is rotatable within the brace.

6. The pipe filtering assembly of claim 5, the head further comprising:
a bar being perpendicular to the straight side of the peripheral wall; and
a dome being coupled to the bar distally to the straight side, the dome having a diameter exceeding a diameter of the bar.

7. The pipe filtering assembly of claim 3, further comprising a rail being coupled to the first pipe and the second pipe, the rail engaging the filter when the filter is coupled to the second pipe wherein the rail is configured to fix a position of the filter relative to the first pipe, the rail further including a groove having a shape being complementary to a shape of the peripheral wall of the fin wherein the peripheral wall is positionable within the groove.

8. The pipe filtering assembly of claim 3, wherein the peripheral wall has a pair of opposing lateral sides and a curved side being coupled to and extending between the pair of opposing lateral sides, wherein a straight side is coupled to and extends between the pair of opposing lateral sides, the straight side being distal to the curved side, wherein the mesh panel extends between the pair of opposing lateral sides, the curved side, and the straight side.

9. The pipe filtering assembly of claim 8, wherein the curved side has an interior face being positioned adjacent to the mesh panel, the interior face being convexly arcuate between a primary side of the pair of opposing lateral sides and a secondary side of the pair of opposing lateral sides.

10. The pipe filtering assembly of claim 8, wherein the straight side is perpendicular to the pair of opposing lateral sides.

11. The pipe filtering assembly of claim 2, wherein the cap has a circular shape being complementary to a shape of the opening into the second pipe.

12. The pipe filtering assembly of claim 2, wherein the top plate has an upper diameter and wherein the base has a lower diameter, the upper diameter exceeding the lower diameter wherein the base is positionable within the opening, the upper diameter exceeding an inner diameter of the second pipe wherein the top plate is positionable on the distal edge of the second pipe.

13. The pipe filtering assembly of claim 2, wherein the second pipe has a threaded inner surface being positioned adjacent to the distal edge, the base of the cap having a threaded outer surface, the threaded outer surface of the base being complementary to the threaded inner surface of the second pipe wherein the cap is threadably couplable to the second pipe.

14. The pipe filtering assembly of claim 2, further comprising a grip being coupled to and extending upwardly from the top plate, the grip being configured to facilitate a user in decoupling the cap from the second pipe.

15. The pipe filtering assembly of claim 14, wherein the grip has a square shape.

16. The pipe filtering assembly of claim 14, wherein the grip has a beveled upper edge being distal to the top plate of the cap.

17. The pipe filtering assembly of claim 1, further comprising a rail being coupled to the first pipe and the second pipe, the rail engaging the filter when the filter is coupled to the second pipe wherein the rail is configured to fix a position of the filter relative to the first pipe.

18. The pipe filtering assembly of claim 17, wherein the rail is centrally positioned between the first end and the second end of the pair of open ends of the first pipe.

19. The pipe filtering assembly of claim 1, wherein the first pipe is configured to be fluidly coupled to the drainpipe wherein the first end defines an inlet into the conduit from a primary pipe of the drainpipe and the second end defines an outlet from the conduit into a secondary pipe of the drainpipe, the filter being configured to inhibit the solid debris from passing into the secondary pipe of the drainpipe through the outlet.

20. A pipe filtering assembly comprising:
a first pipe being elongated, the first pipe having a pair of open ends being configured for connection to a drainpipe, the first pipe defining a conduit between the pair of open ends;
a second pipe being coupled to the first pipe between the pair of open ends wherein the second pipe is in environmental communication with the conduit between the pair of open ends of the first pipe, the second pipe having a distal edge relative to the first pipe defining an opening into the second pipe;
a filter being releasably couplable to the second pipe, the filter extending into the second pipe wherein the filter is configured to inhibit solid debris entering the conduit through the a first end of the pair of open ends from exiting the conduit through a second end of the pair of open ends when the filter is coupled to the second pipe wherein the filter is configured to define a collection point for the solid debris to facilitate removal of the solid debris and inhibit the conduit from becoming fully clogged by the solid debris, the filter further comprising:
a cap having a top plate and a base, the cap having a circular shape being complementary to a shape of the opening into the second pipe, the top plate having an upper diameter, the base having a lower diameter, the upper diameter exceeding the lower diameter wherein the base is positionable within the opening, the upper diameter exceeding an inner diameter of the second pipe wherein the top plate is positionable on the distal edge of the second pipe;
the second pipe having a threaded inner surface being positioned adjacent to the distal edge, the base of the cap having a threaded outer surface, the threaded outer surface of the base being complementary to the threaded inner surface of the second pipe wherein the cap is threadably couplable to the second pipe;
a grip being coupled to and extending upwardly from the top plate, the grip being configured to facilitate a user in decoupling the cap from the second pipe, the grip having a square shape, the grip having a beveled upper edge being distal to the top plate of the cap;
a fin being coupled to and extending downwardly from the base of the cap, the fin extending through the second pipe and into the conduit of the first pipe wherein the fin is positioned between the first end and the second end of the pair of open ends when the filter is coupled to the second pipe, the fin further comprising:
a peripheral wall having a pair of opposing lateral sides and a curved side being coupled to and extending between the pair of opposing lateral sides, the pair of opposing lateral sides being parallel to each other, a straight side being coupled to and extending between the pair of opposing lateral sides, the straight side being distal to the curved side wherein the straight side is positioned proximate to the cap, the straight side being perpendicular to the pair of opposing lateral sides, the straight side having a length being smaller than the lower diameter of the base of the cap;
a mesh panel being coupled to the peripheral wall, the mesh panel extending between the pair of opposing lateral sides, the curved side, and the straight side, the mesh panel being foraminous wherein the mesh panel is configured to inhibit the solid debris from passing through the filter while permitting fluids to pass through the filter;
wherein the curved side has an interior face being positioned adjacent to the mesh panel, the interior face being convexly arcuate between a primary side of the pair of opposing lateral sides and a secondary side of the pair of opposing lateral sides,
a coupler pivotably coupling the fin to the base of the cap wherein the fin is configured to rotate around the coupler beneath the cap, the coupler further comprising:
a head being coupled to and extending upwardly from the straight side of the peripheral wall, the head further comprising:
a bar being perpendicular to the straight side of the peripheral wall;
a dome being coupled to the bar distally to the straight side, the dome having a diameter exceeding a diameter of the bar;
a brace being coupled to and extending downwardly from the base of the cap, the brace being coupled to the head wherein the head is rotatable within the brace;
a rail being coupled to the first pipe and the second pipe, the rail being positioned on an interior surface of the first pipe and the second pipe, the rail being centrally positioned between the first end and the second end of the pair of open ends of the first pipe, the rail engaging the filter when the filter is coupled to the second pipe wherein the rail is configured to fix a position of the filter relative to the first pipe, the rail further comprising:
a groove having a shape being complementary to a shape of the peripheral wall of the fin wherein the peripheral wall is positionable within the groove;
a free upper end being positioned within the second pipe, the free upper end being spaced from the distal edge of the second pipe; and
wherein the first pipe is configured to be fluidly coupled to the drainpipe wherein the first end defines an inlet into the conduit from a primary pipe of the drainpipe and the second end defines an outlet from the conduit into a secondary pipe of the drainpipe, the filter being configured to inhibit the solid debris from passing into the secondary pipe of the drainpipe through the outlet.
